(19) United States
(12) Patent Application Publication
(10) Pub. No.: US 2016/0299995 A1
(43) Pub. Date: Oct. 13, 2016

(54) ADVANCED OPTIONS FOR POWER SUPPLY DESIGNS

(71) Applicant: TEXAS INSTRUMENTS INCORPORATED, Dallas, TX (US)

(72) Inventors: Abhishek GUPTA, Frisco, TX (US); Dien MAC, San Jose, CA (US); Charul SAXENA, Santa Clara, CA (US); Kevin IP, San Jose, CA (US); Jeff PERRY, Cupertino, CA (US)

(21) Appl. No.: 15/098,155

(22) Filed: Apr. 13, 2016

Related U.S. Application Data
(60) Provisional application No. 62/146,667, filed on Apr. 13, 2015.

(51) Int. Cl. G06F 17/50; G06F 17/30

(52) U.S. Cl. CPC G06F 17/50; G06F 17/30312; G06F 17/30424

(57) ABSTRACT

A system stores information of various electrical components and includes a computing resource. The resource receives design requirements indicative of a desired power supply design (e.g., an input voltage, an output voltage, an output current, and a value indicative of maximum output voltage ripple). The resource determines electrical components that comply with the input voltage, output voltage, and output current and then generate power supply designs that satisfy the input voltage, output voltage, and output current. For each power supply design, the resource calculates an output capacitor and an inductor. The capacitor is selected by adjusting the capacitor's ESR. A post ripple filter circuit may be added. Inductor ripple may be reduced by sizing the inductor for a target ripple. The provides the power supply designs in a ranked order.

### CROSS-REFERENCE TO RELATED APPLICATIONS

The present application claims priority to U.S. Provisional Patent Application No. 62/146,667, filed Apr. 13, 2015, titled “Advanced Design Options For Single And Multi-Rail Power Supply Design Generation And Optimization,” which is hereby incorporated herein by reference in its entirety.

### BACKGROUND

Power supplies perform the conversion of one form of electrical power to another. Some power supplies convert AC line voltage to a well-regulated and typically lower DC voltage for electronic devices. Other power supplies convert an input DC voltage at one voltage level into an output DC voltage at a different voltage and at a maximum rated current. A power supply may be designed to meet design requirements that call for production of a desired voltage and current from a desired input source. In addition, design parameters such as power supply efficiency, component and printed circuit board footprint size, and overall component cost may be considered when designing a power supply.

### BRIEF DESCRIPTION OF THE DRAWINGS

For a detailed description of various examples, reference will now be made to the accompanying drawings in which:

FIG. 1 illustrates a system for determining and visualizing power supply designs in accordance with various embodiments;

FIG. 2 illustrates an exemplary power supply design;

FIG. 3 illustrates an alternate exemplary power supply design;

FIG. 4 illustrates another exemplary power supply design;

FIG. 5 illustrates a modularization of a visualizer design tool application in accordance with various embodiments;

FIG. 6 illustrates a process flow for determining and visualizing power supply designs in accordance with various embodiments;

FIG. 7 illustrates a user interface for a visualizer design tool application in accordance with various embodiments;

FIG. 8 shows an user interface for providing basic user inputs and a controlling the ranking of the power supply design results in accordance with various embodiments;

FIG. 9 shows a user interface for a user to select advanced filter options in accordance with various embodiments;

FIG. 10 illustrates various advanced options for a user to control the design of a power supply circuit in accordance with various embodiments;

FIG. 11 illustrates a resulting user interface after a user has selected one or more advanced options in accordance with various embodiment;

FIG. 12 shows user controls for specifying sorting weights in accordance with various embodiments; and

FIG. 13 shows a method in accordance with various embodiments.

### SUMMARY

In one embodiment, a system includes a database that stores information of various electrical components and includes a computing resource. The resource receives design requirements indicative of a desired power supply design (e.g., an input voltage, an output voltage, an output current, and a value indicative of maximum output voltage ripple). The resource determines electrical components that comply with the input voltage, output voltage, and output current and then generate power supply designs that satisfy the input voltage, output voltage, and output current. For each power supply design, the resource calculates an capacitor value and a capacitor ripple, a total ripple based on the value indicative of maximum output voltage ripple, and a capacitor ESR value based on the total ripple and based on the output capacitor ripple. The resource selects a capacitor based on the calculated output capacitor value and the capacitor equivalent series resistance value, and provides the power supply designs in a ranked order.

In another embodiment, a method includes receiving, at a computing resource, a plurality of design requirements including an input voltage value, an output voltage value, an output current, and at least one of a frequency, a soft start time value, a value indicative of maximum output voltage ripple, a value indicative of maximum inductor current ripple. The method further includes identifying a plurality of electrical components from a database that comply with the design requirements and generating a plurality of power supply designs including the identified plurality of electrical components, each design satisfying the design requirements. The method also includes transmitting the generated plurality of power supply designs.

In yet another embodiment, a method includes receiving, at a computing resource, a plurality of basic design requirements including an input voltage value, an output voltage value, an output current. The method further includes generating, by the computing resource, data to be populated into a user interface, the data including user-selectable advanced options, the advanced options including a frequency, a soft start time value, a value indicative of maximum output voltage ripple, a value indicative of maximum inductor current ripple, and a device physical attribute. The method also includes transmitting, by the computing resource, the data across a network for inclusion in a user interface, and receiving a selected advanced option. Using electrical components from a data store, the method includes generating a plurality of power supply designs that satisfy the basic design requirements and the selected advanced option. The method further includes transmitting, by the computing resource, the generated plurality of power supply designs.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct wired or wireless connection. Thus, if a first device couples to a second device, that connection may be through a direct connection or through an indirect connection via other devices and connections. The term “based on” means “based at least on.”

A design tool may dynamically calculate many designs for a given circuit design problem, each design having different characteristics and embodying different design tradeoffs. To allow a user to determine which one of the designs is best for the user's application, the design tool may allow the user to visualize the tradeoffs between a multitude of circuit designs.

For example, a manufacturer of power supply components may be able to supply on the order of dozens of possible designs that satisfy a given set of power supply requirements. These designs may include various power supply components and supporting components to allow the power supply components to function for the particular application. Additionally, these different designs may take up different footprints, have different electrical efficiency ratings, and have different component costs.

Comparing each of the possible designs by hand to determine an appropriate power supply design may require significant work. For example, a user may create each power supply design individually, simulate each individual design, and compare the resultant simulations to one another to determine the most preferred design. Depending on the number of possible designs, and the number of loads requiring power, this process may take many days or weeks.

To overcome these and other deficiencies in existing design tools, a design tool may allow a user to create multiple possible designs at once for a given set of design requirements. The design tool may allow the user to create the set of designs optimized for desired characteristics such as efficiency, footprint, bill of materials cost, peak to peak voltage ripple or other parameters.

The design tool may further allow the user to specify parameters of the designs to visually compare. This allows the user to immediately compare different options in a graphical manner and choose the best one for the user's needs. The design tool may display the results in a tabular form which can be filtered using various graphical user interface controls such as sliders or selection boxes. In addition to displaying the designs in a tabular list, the design tool may further display the results in graphical form to allow the user to visually see the differences in the designs such as footprint versus efficiency versus cost.

The design tool disclosed herein permits a user to input and/or select numerous advanced design values and criteria besides basic inputs such as input voltage, output voltage, and output current. For example, the design tool may permit a user to specify a value indicative of a maximum output voltage ripple, an output inductor current ripple, a frequency value, whether the power supply device is to be synchronized to an external frequency source, etc. Any of these or other advanced options are used by the design tool when generating the power supply design circuits. Because the user is able to specify many more design criteria as inputs to the design tool, the user will spend far less time evaluating the various resulting design circuits the tool produces.

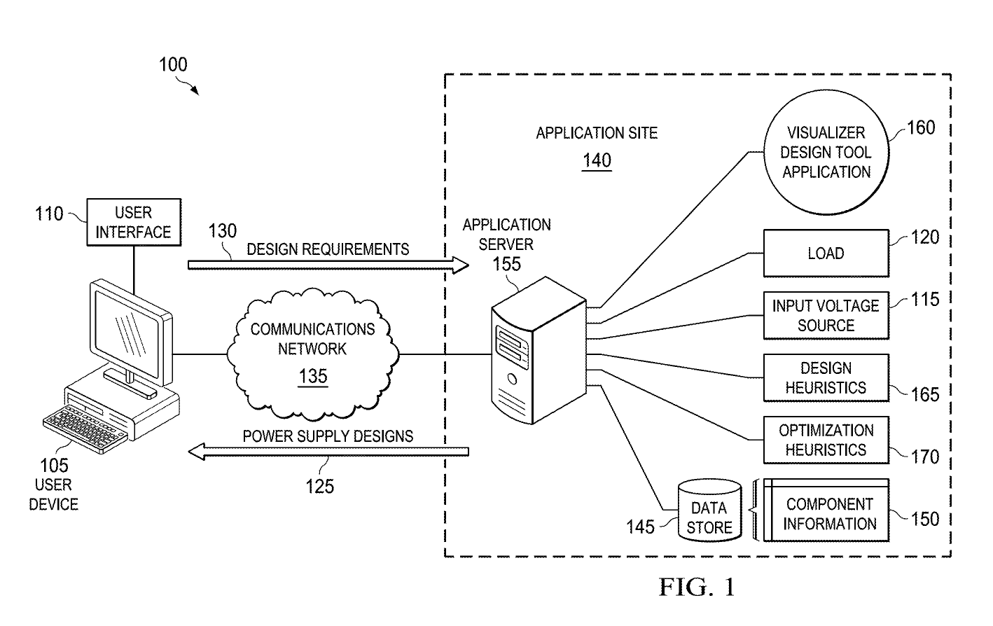

FIG. 1 illustrates an exemplary system 100 for determining and visualizing power supply designs. As illustrated in FIG. 1 the exemplary system includes a user device 105 configured to provide a user interface 110 configured to receive design requirements 130 including an input voltage source 115 and a load 120 and display a set of power supply designs 125 responsive to the design requirements 130. The system 100 further includes a communications network 135 in selective communication with the user device 105 and an application site 140. The application site 140 includes a data store 145 configured to store component information 150. The application site 140 further includes an application computing resource such as application server 155 configured to run a visualizer design tool application 160. The visualizer design tool application 160 may receive the design requirements 130, and may produce the set of power supply designs 125 responsive to the design requirements 130, relevant design heuristics 165 and optimization heuristics 170, as well as selected component information 150 from the data store 145. The visualizer design tool app 160 may generate a set of power supply designs based on one or more advanced design options in addition to or in lieu of the basic design options, according to one or more of the techniques described in this disclosure. System 100 may take many different forms and include multiple and/or alternate components and facilities. While an exemplary system 100 is shown in FIG. 1, the exemplary components illustrated are not intended to be limiting. Indeed, additional or alternative components and/or implementations may be used.

The user device 105 may be a device configured to be operated by one or more users, such as a cellular telephone, laptop computer, tablet computing device, personal digital assistant, or desktop computer workstation, among others. The user device 105 may include one or more components capable of receiving input from a user, and providing output to the user.

The user interface 110 may be an interface configured to allow for the effective operation and control of the user device 105. The user interface 110 may further provide feedback and other output to the user to aid the user in making operational decisions with respect to the user device 105. Exemplary user interfaces 110 may include input devices such as keyboards, buttons, and microphones, and output devices such as display screens and loudspeakers. As a particular example, a user interface 110 may be implemented by way of one or more web pages displayed by the user device 105 by way of a web browser software program. Such a web-based user interface 110 may accept input from a user by way of one or more controls on a web page and may provide output by displaying web pages to the user including feedback or other outputs of the system 100. As another example, a user interface 110 may be implemented by way of a self contained rich internet application (RIA) utilizing an engine such as Adobe Flash, where the RIA may accept input from a user by way of one or more controls and provide output that may be viewed by the user on the user device 105.

An input voltage source 115 may represent a device or system that produces or derives an electromotive force between its terminals. Input voltage sources 115 may be specified by the voltage and maximum current draw they provide, and may further be specified by a name to aid in identification. A load 120 may represent an electrical or other circuit that requires electrical power to operate. Loads 120 may be specified by a required voltage and maximum current draw. Loads 120 may be identified according to a name or other identifier to aid in their identification. A power supply may represent a design for a source of electrical power, and a power supply design 125 may be a circuit including various components that draw power from one or more input voltage sources 115 and supply electrical energy to at least one load 120.

The design requirements 130 may include information regarding the design of a set of solutions to a circuit design problem. For example, the design requirements 130 may include information regarding a power supply load 120 to be powered by an input voltage source 115. The information regarding the load 120 to be powered may include information such as a required voltage, a required current, a name or other identifier, and other power supply attributes of the loads 120. The information regarding the input voltage source 115 may include information such as minimum, maximum, and nominal input voltage, maximum input current, and other design inputs about one or more input voltage sources 115. The information may further include additional power supply parameters, such as ambient temperature. The design requirements may further include advanced design options, as described in this disclosure, including, e.g., design control options, component selection options, and operating value options.

The communications network 135 may include a mixture of wired (e.g., fiber and copper) and wireless mechanisms that incorporate related infrastructure and accompanying network elements. Illustrative communication networks 135 may include the Internet, an intranet, the Public Switched Telephone Network (PSTN), and a cellular telephone network. The communications network 135 may include multiple interconnected networks and/or sub-networks that provide communications services, including data transfer and other network services to at least one user device 105 connected to the communications network 135.

The communications network 135 may be in selective communication with an application site 140. The application site 140 may be a hosting platform, such as a web hosting platform, configured to make applications available over the communications network 135. To perform the hosting functions, the application site 140 may include computing devices such as one or more data stores 145 and application servers 155.

The data store 145 may include one or more data storage mediums, devices, or configurations, and may employ various types, forms, and/or combinations of storage media, including but not limited to hard disk drives, flash drives, read-only memory, and random access memory. The data store 145 may include various technologies useful for storing and accessing any suitable type or form of electronic data, which may be referred to as content. Content may include computer-readable data in any form, including, but not limited to video, image, text, document, audio, audiovisual, metadata, and other types of files or data. In some instances content may be stored in a relational format, such as via a relational database management system (RDBMS), while in other instances content may be stored in a hierarchical or flat file system. In particular, the data store 145 may store content including component information 150. Notably, the data store 145 maintains information with respect to individual components, not completed designs, solutions, or formulations.

The component information 150 may include information on the individual components, such as power supply regulators (switching regulators, low drop out regulators (LDOs), switched capacitors or other types of voltage regulators), capacitors, resistors, diodes, etc. Component information 150 may be received from manufacturers or suppliers in various forms, such as parts information sheets, parts catalogs, schematics, among others. The received component information 150 may be formatted and saved into the data store 145 for use in determining designs. Exemplary component information 150 may include part cost, whether the part is in stock, part dimensions and footprint, pin configuration, minimum and maximum ranges of operation, light output, heat sink requirements, efficiency information, graphs of various characteristics of operation, among other exemplary characteristics. The component information 150 includes information about the components themselves, not the components in combination with other components. The component information 150 is, or is stored in, a database.

The application site 140 may further include an application server 155. The application server 155 may be implemented as a combination of hardware and software, and may include one or more software applications or processes for causing one or more computer processors (or other circuits or circuitry) to perform the operations of the application server 155 described herein. The application server 155 may include one or more processors, memory, network interfaces, and other hardware. The application server is a type of computing resource that executes the design tool application 160. The computing resource may be a single computer such as a server (e.g., application server 155), or multiple computers networked together.

A visualizer design tool application 160 may be one application executed on the application server 155, wherein the visualizer design tool application 160 may be implemented at least in part by instructions stored on one or more computer-readable media. The visualizer design tool application 160 may include instructions to cause the application server 155 to receive design requirements 130 relating to an input voltage source 115 and a load 120, query the data store 145 for component information 150 related to the design requirements 130, produce a set of power supply designs 125 responsive to the design requirements 130 and component information 150, and provide for visualization of the determined power supply designs 125 for further analysis and use.

The visualizer design tool application 160 may utilize design heuristics 165 when determining the set of power supply designs 125 responsive to the design requirements 130. Design heuristics 165 may include rules related to the generation of different power supply topologies (e.g., Boost, Buck, Buck-Boost, etc.) which may be appropriate to power the loads 120 specified by the design requirements 130.

The visualizer design tool application 160 may utilize optimization heuristics 170 when determining the set of power supply designs 125 responsive to the design requirements 130. These optimizations may guide the determination of some or even all of the components and supporting component of the power supply designs 125. Optimization heuristics 170 may be responsive to design requirements 130 indicative of tradeoffs between various design goals, and may be utilized to prefer one or more parameters over other parameters of a component or design. Design goals to be optimized by optimization heuristics 170 may include small component footprint, efficiency, cost, thermal dissipation, and power utilized, among others. As an example, an optimization heuristic 170 for designs with a smaller footprint may optimize for size by choosing components with relatively smaller footprints that still satisfy the design requirements 130, but at the expense of other parameters such as efficiency. As another example, an optimization heuristic 170 for designs with a higher efficiency may optimize by choosing components capable of being utilized at a relatively lower switching frequency while still satisfying the design requirements 130, but at the expense of other parameters such as cost.

Computer-executable instructions may be compiled or interpreted from computer programs created using a variety of well known programming languages and/or technologies, including, without limitation, and either alone or in combination, Java™, C, C++, Visual Basic, Java Script, Perl, PL/SQL, Actionscript, etc. The visualizer design tool application 160 may accordingly be written at least in part according to a number of these and other programming languages and technologies, or a combination thereof.

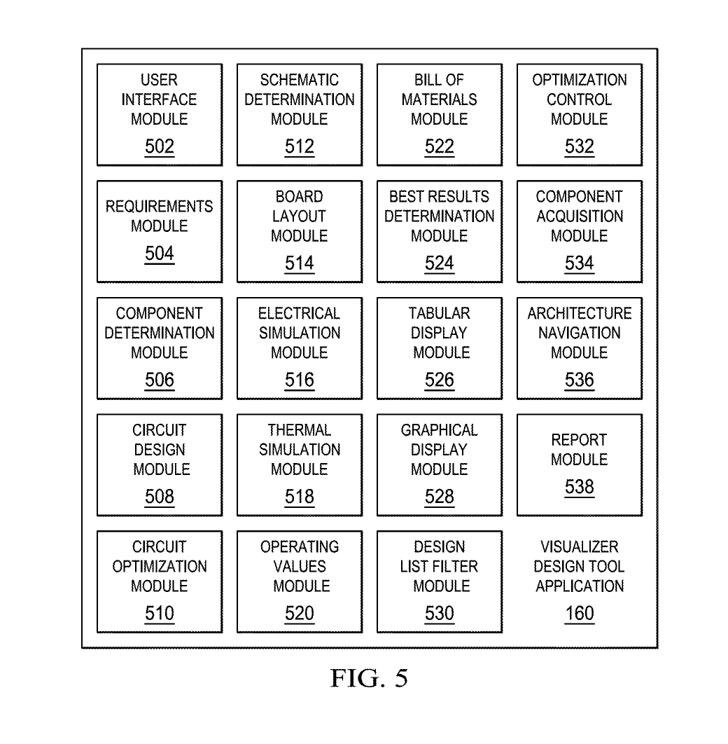

In some instances, the visualizer design tool application 160 is provided as software that when executed by a processor of the application server 155 provides the operations described herein. Alternatively, the visualizer design tool application 160 may be provided as hardware or firmware, or combinations of software, hardware and/or firmware. An exemplary modularization of the visualizer design tool application 160 is discussed in further detail below with respect to FIG. 5.

In general, computing systems and/or devices, such as user device 105, application server 155, and data store 145 may employ any of a variety of computer operating systems. Examples of computing devices include, without limitation, a computer workstation, a server, a desktop, notebook, laptop, or handheld computer, or some other known computing system and/or device.

Computing devices, such as data store 145 and application server 155 generally include computer-executable instructions, where the instructions may be executable by one or more computing devices such as those listed above. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, such as such as data store 145 described herein, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

While FIG. 1 illustrates an exemplary system 100, other implementations may be used. In some implementations, the system 100 may be implemented as an off-line or self-contained computing device based configuration. In such an implementation, the application server 155 and visualizer design tool application 160 may be implemented by a back-end calculation engine running on the computing device. In some implementations, the visualizer design tool application 160 may be executed by way of a self-contained rich internet application (RIA) utilizing an engine such as Adobe Flash. For example, the RIA may be downloaded by a client from a server by way of a network such as the Internet or an intranet, and where most or substantially all of the calculations performed by the system 100 may be performed on the client using the RIA, without need to go back to the server again during a design session.

Further, additional elements may be included or elements shown in FIG. 1 may be omitted or modified. For example, one or more of the user device 105, data store 145, and application server 155 may be combined in certain implementations. As another example, a system may include multiple data stores 145 and/or application servers 155. In still further examples, visualizer design tool application 160 may be implemented across multiple application servers 155. While communications network 135 is shown in the illustrated embodiment, in other embodiments the communications network 135 may be omitted entirely and the user device 105 may be connected directly to the application site 140. In still other examples, the visualizer design tool application 160 may be executed in whole or in part by the user device 105.

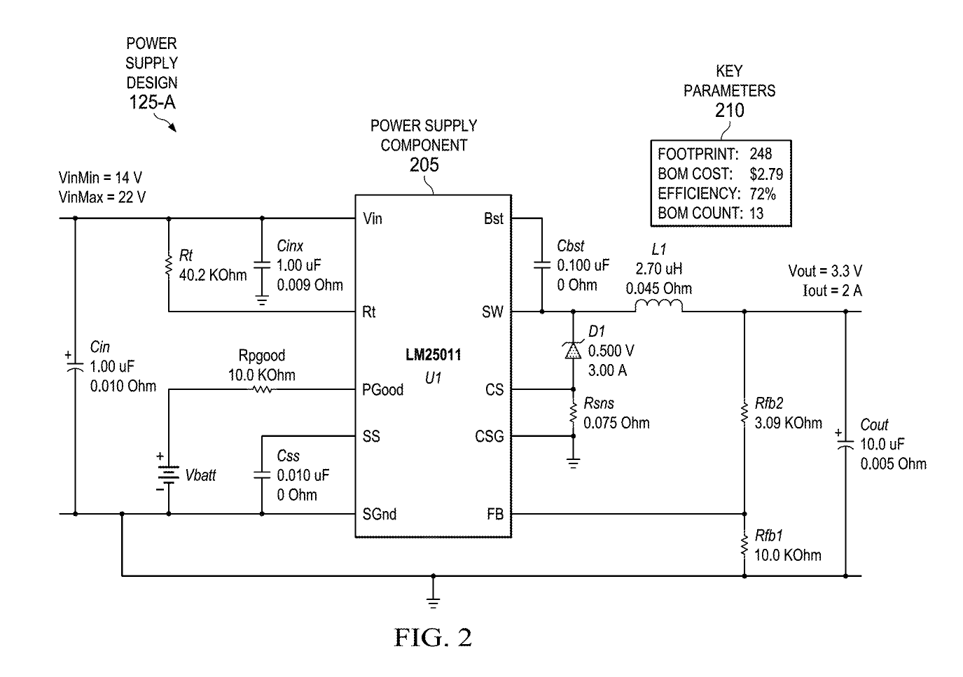

FIG. 2 illustrates an exemplary power supply design 125-A. The power supply design 125-A is configured to power a load 120 from an input voltage source 115 as specified by exemplary design requirements 130. In particular, the exemplary design requirements 130 specify an input voltage source 115 of 14 to 22 Volts and a load 120 of 3.3 Volts at 2 Amps. As shown in FIG. 2, the power supply design 125-A utilizes an LM25011 power supply component 205 and various supporting components to meet the design requirements 130.

In addition to meeting the design requirements 130, the power supply design 125-A embodies various additional parameters 210. Parameters 210 are parameters of power supply designs 125 such as electrical efficiency, footprint, bill of materials cost, bill of materials count, peak to peak voltage ripple or other parameters that may be used to aid in the visualization of tradeoffs between power supply designs 125.

The parameters 210 may be quantified in various ways. The footprint may be represented as square millimeters of board space utilized by the power supply design 125-A. The bill of materials count may be represented by a number of total components required to build the power supply design 125-A, including a board, a power supply switching component, as well as any supporting components. The bill of materials cost may be represented by the total dollar cost of each of the items used in the construction of the power supply design 125-A. The efficiency may be represented by calculating the power dissipation of the power supply design 125-A.

As shown, the parameters 210 of the power supply design 125-A include a footprint of 248 mm, a bill of materials (BOM) cost of $2.79, an electrical efficiency of 72%, and a BOM count of 13 parts.

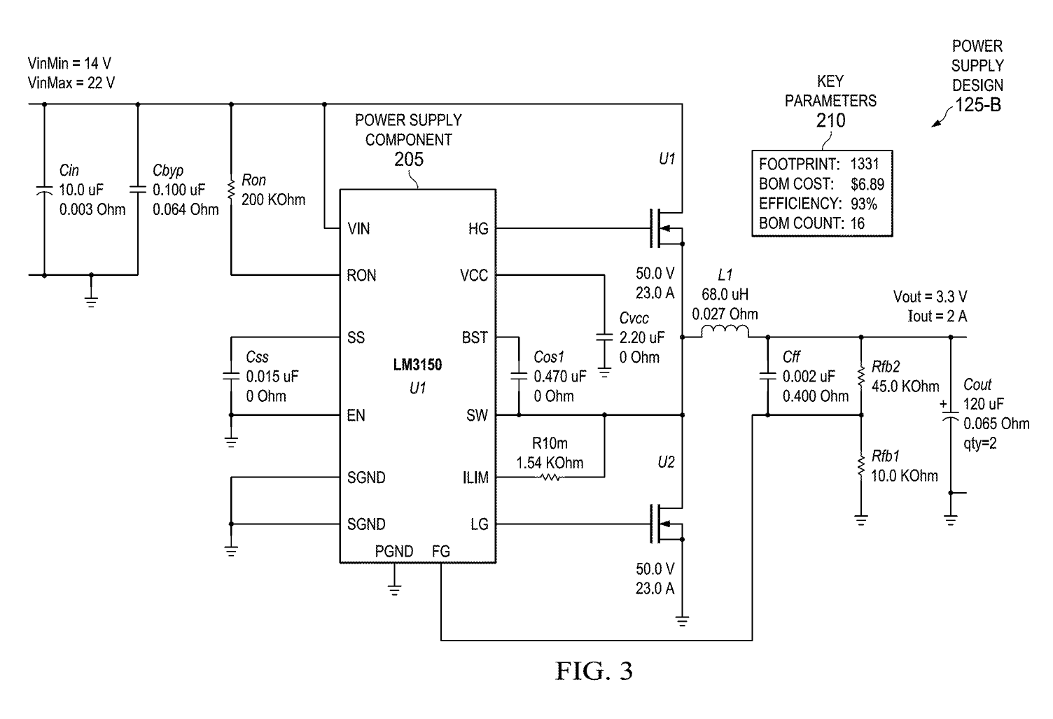

FIG. 3 illustrates an alternate exemplary power supply design 125-B. The illustrated power supply design 125-B is also configured to power the same load 120 of 3.3V at 2 Amps from the same input voltage source 115 of 14 to 22 Volts as specified by the design requirements 130. Rather than utilizing an LM25011 power supply component 205, the power supply design 125-B utilizes an LM3150 power supply component 205 and various supporting components to meet the design requirements 130.

Due to differences in the power supply design 125-B as compared with power supply design 125-A, the parameters 210 of the power supply design 125-B differ considerably from those of power supply design 125-A. As shown, the parameters 210 of the power supply design 125-B include a footprint of 1331 mm, a BOM cost of $6.89, an electrical efficiency of 93%, and a BOM count of 16 parts. Thus, power supply design 125-B can be seen to be far more efficient than power supply design 125-A, but at the expense of design footprint, BOM cost, and BOM count.

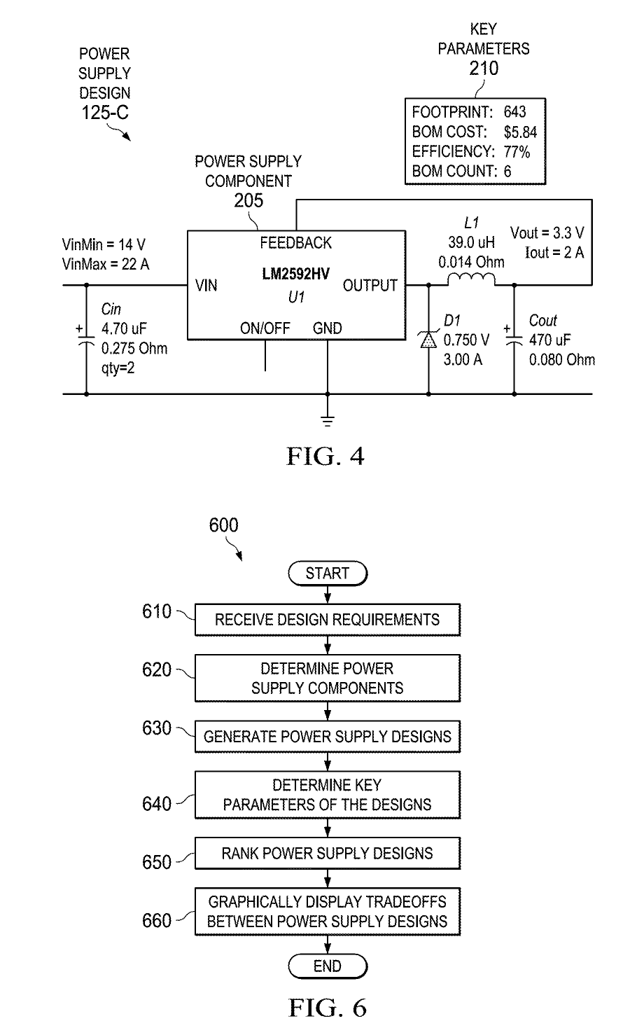

FIG. 4 illustrates another exemplary power supply design 125-C. The illustrated power supply design 125-C is also configured to power the same load 120 of 3.3V at 2 Amps from the same input voltage source 115 of 14 to 22 Volts as specified by the design requirements 130. Rather than utilizing an LM25011 power supply component 205 or an LM3150 power supply component 205, the power supply design 125-C utilizes an LM2592HV power supply component 205 and various supporting components to meet the design requirements 130.

Due to differences in the power supply design 125-C as compared with power supply designs 125-A and 125-B, the parameters 210 of the power supply design 125-C differ considerably from those of power supply designs 125-A and 125-B. As shown, the parameters 210 of the power supply design 125-B include a footprint of 643 mm, a BOM cost of $5.84, an electrical efficiency of 77%, and a BOM count of 6 parts. Thus, power supply design 125-C can be seen to include far fewer parts than power supply designs 125-A and 125-B. However, power supply design 125-C is more expensive and larger than power supply design 125-A. Power supply design 125-C is also less efficient and smaller than power supply design 125-B, while costing almost as much.

While three different power supply designs 125 are shown in FIGS. 2-4, many more power supply designs 125 satisfying the indicated design requirements 130 may be possible, each with its own various parameters 210. Sorting these power supply designs 125 by one or more parameters 210 may allow a user to determine which design is best at only one of the parameters 210 at a time. However, through use of the visualizer design tool application 160, a user may advantageously visualize the tradeoffs between multiple parameters 210 at once, and between a multitude of power supply designs 125, thus allowing a user to determine the power supply design 125 that embodies tradeoffs best suited to the situation.

FIG. 5 illustrates an exemplary modularization of the visualizer design tool application 160. As shown, the visualizer design tool application 160 may include a user interface module 502, requirements module 504, a component determination module 506, a circuit design module 508, a circuit optimization module 510, a schematic determination module 512, a board layout module 514, an electrical simulation module 516, a thermal simulation module 518, an operating values module 520, a bill of materials module 522, a best results determination module 524, a tabular display module 526, a graphical display module 528, a design list filter module 530, an optimization control module 532, a component acquisition module 534, an architecture navigation module 536, and a report module 538. Although only one example of the modularization of the visualizer design tool application 160 is illustrated and described, it should be understood that the operations thereof may be provided by fewer, greater, or differently named modules.

The user interface module 502 may be configured to provide the user interface 110 to be displayed by way of the user device 105. For example, the user interface module 502 may be implemented by way of one or more web pages configured to accept the design requirements 130 from a user and provide output to the user including power supply designs 125. The user interface module 502 may be implemented using technologies such as Java, AJAX, Adobe Flex, Adobe Flash, Microsoft .NET, among others. The user interface module 502 may be configured to generate web pages via the application server 155 to be transmitted to the user device 105 via the communications network 135. These web pages may then be viewed by the user on the user device 105 using a web browser program.

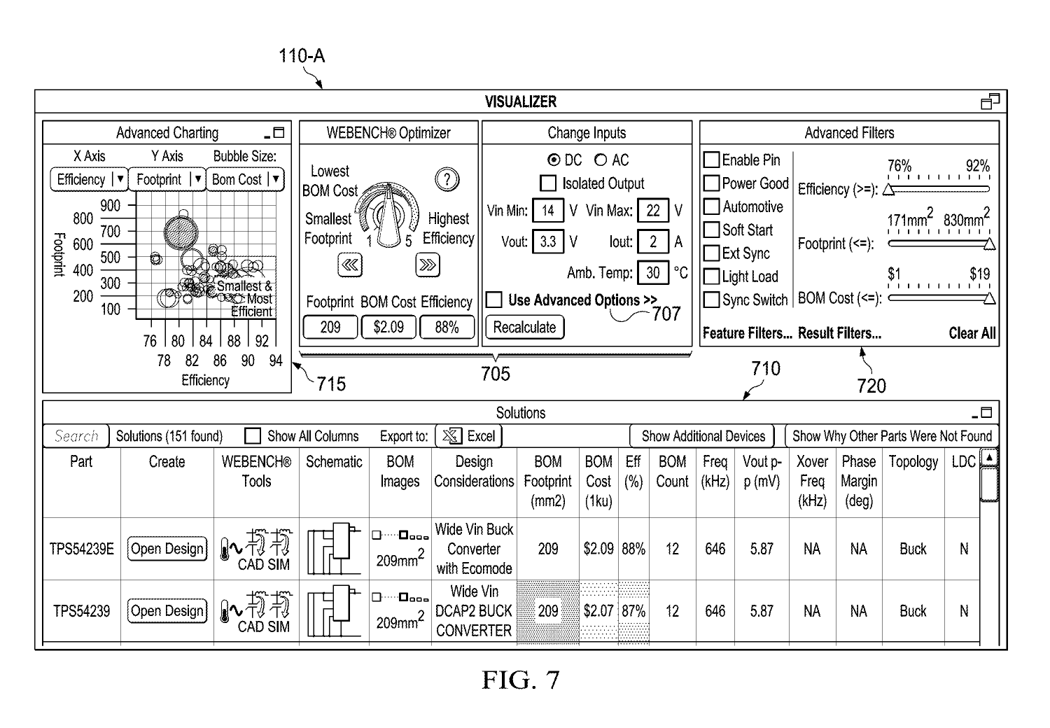

Exemplary user interfaces 110 allowing for the specification of design requirements 130 and the viewing of power supply designs 125 are illustrated with respect to FIGS. 7-12 described below. It should be noted that the while specific user interfaces 110 are illustrated in the exemplary figures, the particular user interfaces 110 presented by the visualizer design tool application 160 and the user interface module 502 may vary from implementation to implementation.

The requirements module 504 may be configured to utilize the user interface module 502 to allow the user of the user device 105 to specify design requirements 130 for the power supply designs 125. For example, the requirements module 504 may cause the user interface module 502 to generate web pages configured for receiving the design requirements 130.

The requirements module 504 may be configured to allow a user to specify design requirements 130 including an input voltage source 115. For example, a user may provide minimum, maximum, and nominal input voltage, ambient temperature, maximum input current and/or other critical design inputs about the input voltage source 115 and power supply 125.

The requirements module 504 may further be configured to allow a user to specify design requirements 130 including a load 120 to be provided power by the power supply design 125. For example, the user may provide voltage, current, name and other power supply attributes for a power supply load 120. In some examples, the requirements module 504 may allow for the import or upload of data regarding the design requirements 130.

The requirements module 504 may also be configured to allow a user to specify design requirements 130 including a preferred channel supplier and/or a preferred manufacturer. For example, the user may select a manufacturer of power supply components 205 to inform the visualizer design tool application 160 to choose power supply components 205 only from that manufacturer. As another example, the user may select a preferred channel supplier to inform the visualizer design tool application 160 to choose only from parts available for purchase from the indicated supplier. As yet another example, a preferred channel supplier or manufacturer may be automatically be selected based on uniform resource locator (URL) navigation. Selection of a manufacturer or a channel supplier may indicate a preference for parts from the selection manufacturer or supplier. Information regarding what parts and manufacturers are available from a supplier may be received from the suppliers, such as from supplier line cards, and may be stored in the data store 145.

The requirements module 504 also may be configured to allow a user to provide advanced options for use by the design tool in designing the power supply circuits. Examples of advanced options may include any or all of:
A nominal input voltage between a minimum and maximum input voltage
A nominal output operating current that is equal to or less than a maximum specified output current
A frequency to be implemented internal to the power supply device
Whether the power supply device's frequency is to be synchronized to an external frequency and the value of the external frequency
A startup time (or softstart time) which dictates the time it will take for the circuit to reach a steady-state operating point thereby reducing stress (e.g., reducing current surges or inrush current)
Output voltage ripple
Inductor current ripple
Whether an output filter is to be included in the design
Minimum package size
Minimum area the circuit will occupy on a circuit board
Maximum component height
Whether only ceramic capacitors are to be used in the design
Whether shielded inductors are to be used in the design
Whether components from a particular manufacturer are to be used
Whether only matching transistor pairs are to be used
Whether only components currently in stock are to be used
Whether only components are to be used that have a currently valid price
   Other or different advanced options may be used as well.

The component determination module 506 may be configured to determine one or more components that could be used to build circuits configured to meet the design requirements 130. For example, the component determination module 506 may be configured to determine one or more power supply components 205 that could be used to build circuits configured to power a power supply load 120 from an input voltage source 115. The component determination module 506 may determine a power supply component 205 that could satisfy the design requirements 130 by applying filters to component information 150 stored in data store 145. The filters may compare values specified in the design requirements 130 for the load 120, such as output voltage and output current, against values in corresponding information in the component information 150. In instances where a manufacturer or channel supplier is selected, the filters may further filter the component information 150 to include only parts made by the selected manufacturer or only parts or manufacturers available for purchase from the selected channel supplier.

As another example, the component determination module 506 may utilize values from the design requirements 130 relating to the input voltage source 115 as inputs to one or more design heuristics 165, where the outputs of the one or more design heuristics 165 may be used to determine which power supply components 205 could potentially satisfy power supply load 120 from the input voltage source 115. For instance, when designing a boost regulator circuit, a design heuristic 165 may be used to determine which power supply components 205 used in boost regulators may meet the switch current requirements implicit in the load 120 requirements for a particular power supply design 125. Accordingly, to determine which power supply components 205 may be used in that power supply architecture, the input voltage of the input voltage source 115 as well as the output voltage and output current of the load 120 specified by the design requirements 130 may be used to calculate a required switch current rating, where the required switch current rating is compared against the switch current ratings in the component information 150 stored in data store 145 to select only those power supply components 205 that can satisfy the design requirements. 130

Thus, the component determination module 506 may determine a list of possible power supply components 205 satisfying the design requirements 130 that can be used in power supply designs 125. For example, as shown in FIG. 2, an LM25011 power supply component 205 may be used to meet the design requirements 130 for the power supply design 125. As another example, as shown in FIG. 3 an LM3150 power supply component 205 may also be used to meet the design requirements 130. In some examples, the component determination module 506 may further maintain a list of reasons for the exclusion of power supply components 205 that may be unsuitable for use in power supply designs 125 having the design requirements 130, so that a user may be informed why a particular power supply component 205 is not indicated as being available for use.

A circuit may contain many more supporting components in addition to a particular power supply component 205 that may be used to satisfy the design requirements 130. Based on the determined power supply components 205, the circuit design module 508 may be utilized to determine the supporting components, or parameters and bounds for the supporting components. The circuit design module 508 may further be configured to determine a circuit topology indicating how those additional supporting components may be arranged to create the circuit with the power supply components 205.

The circuit design module 508 may utilize design heuristics 165 and including various rules and mathematical formulas to select adequate values for the additional components. For example, if the design requirements 130 indicate that a load 120 is to be provided a minimal output voltage ripple, a design heuristic 165 may indicate that an output capacitor with a low equivalent series resistance (ESR) value may be chosen as a supporting component. As another example, if the design requirements 130 indicate that a power supply may be required to withstand sudden change in load current (i.e., transient response) then a design heuristic 165 may indicate that a larger output capacitor value may be chosen as a supporting component.

In some instances, rather than determine a particular value for a supporting component, the circuit design module 508 may instead utilize design heuristics 165 determine a range of potential values for an additional component of the circuit. For example, for a certain design, an output capacitor must have a capacitance greater than or equal to 100 .mu.F and an equivalent series resistance of less than or equal to 100 m.OMEGA. These rules may then be used by the circuit design module 508 to select supporting components from the parts described in the component information 150 of the data store 145.

The circuit optimization module 510 may be configured to aid in the determination of power supply components 205 and supporting components. For example, the circuit optimization module 510 may determine supporting components that satisfy the range of potential values determined by the circuit design module 508, while also accounting for design preferences indicated in the design requirements 130 through use of optimization heuristics 170. These optimizations and design preferences may accordingly guide the determination of some or even all of the components 205 and supporting components of the power supply designs 125.

Parameters of a component part may be determined based on the component information 150 stored in the data store 145. Accordingly, selection of component parts for a design may be based on an algorithm in which a target value is set for the parameters of the component part. The closer a component parameter is to a target value, the higher the score for that parameter. A weight may also be assigned to each parameter of a component. Thus, a final score for each component may be determined based on the initial score and the weight (e.g., determined as a product of the initial score and the weight). If two parameters with a same deviation from a target value have different weights, the one with a higher weight would receive a higher overall score. This weighted scoring algorithm allows selection of components taking into account multiple parameters at once, keeping a balance between important characteristic factors of the component part such as footprint, parasitic resistance, capacitance, and inductance.

As an example, a design requirement 130 may indicate a preference for power supply designs 125 having high efficiency or low voltage ripple. Accordingly, an optimization heuristic 170 may set a low target for an equivalent series resistance (ESR) parameter of an output capacitor to reduce power dissipation and/or ripple. An optimization heuristic 170 may further set a high weighting for the ESR parameter in relation to other parameters. Using these optimization heuristics 170, capacitors with low ESR would typically achieve higher scores than capacitors with higher ESR, giving the resultant designs improved efficiency.

The optimization heuristics 170 may further allow consideration of other parameters, such as size, capacitance, price and part availability in order to determine an overall score for a component. As an example, design requirements 130 may indicate a preference for designs having high efficiency, low cost, and parts that are in stock. Accordingly, one or more optimization heuristics 170 may place a relatively higher weight on a part being in stock at a fulfillment warehouse, a relatively higher weight on a part having a low price, and a relatively higher weight on a part having a low ESR. In such an example, a capacitor having a low ESR, but being out of stock at the fulfillment warehouse and having a high price may receive a lower overall score than a part one that is in stock, less expensive, but with a higher ESR.

In some instances, one or more of the component determination module 506, the circuit design module 508, and the circuit optimization module 510 may utilize a cutoff to generate up to a maximum number of power supply designs 125. This cutoff may indicate a maximum total number of power supply designs 125 to include in the universe of possible designs. In other instances, a cutoff may indicate a maximum number of components to select for the creation of power supply designs 125. For example, a cutoff may be implemented as a maximum number of power supply components 205 to select from the component information 150 stored in the data store 145 to use in the creation of power supply designs 125.

The schematic determination module 512 may be configured to produce a schematic diagram including the particular power supply component 205 and supporting components determined by the component determination module 506, circuit design module 508, and circuit optimization module 510. In some examples, the schematic determination module 512 may be configured to generate a schematic that may be displayed to a user in a user interface 110 on a web page, by way of the user interface module 502.

For example, the schematic determination module 512 may be configured to draw an electrical schematic by way of the user interface module 502, using vector-based drawing techniques within a web browser application executed by a user device 105. The electrical schematic may show wires and components such as voltage regulator devices and capacitors. In some examples, the schematic determination module 512 may be configured to provide a scale adjustment to allow for a user to adjust the scale at while a schematic is drawn, and zoom in and out of the schematic.

The schematic determination module 512 may further be configured to allow for the selective editing of various components or wires of a schematic diagram, and the schematic determination module 512 may visually indicate which components and/or wires in the schematics may be modifiable. For example, components that are modifiable may be illustrated in color, while components that are non-modifiable may be presented in a black-and-white format. As another example, components that are modifiable may be presented accompanied by a particular graphic.

For components that are indicated as being editable, the schematic determination module 512 may allow for the user to substitute another component for the indicated component. For example, the schematic determination module 512 may allow for the substitution of a resistor or capacitor in the schematic with a part of another value, tolerance, manufacturer, or rating. Additionally, one or more ends of a wire included in the schematic may be capable of being moved by a user to allow for additional customization of the schematic.

The board layout module 514 may be configured to create a printed circuit board (PCB) layout according to a determined schematic, such as an electrical schematic determined by the schematic determination module 512. The board layout module 514 may determine an appropriate PCB layout according to various parameters, including the topology the circuit, the IC selected, the size of the selected components, whether the design requires a large amount of copper to dissipate heat or a heat sink to dissipate heat, and the like.

In some examples, the board layout module 514 may be configured to receive an indication of a size of a board on which to layout the components. For instance, the board layout module 514 may provide controls, by way of user interface module 502, to allow for user specification of one or more of PCB width, PCB height, and PCB mounting depth. In other examples, the board layout module 514 may automatically determine where the components are placed on a printed circuit board and delete the portions of the board not used by the components. Thus, the board layout module 514 may be configured to automatically crop the PCB layout based on the components used in the circuit.

In some examples, the board layout module 514 may be configured to determine a PCB layout according to a predetermined landing area approach. In such an approach, a PCB layout of the design is created with a mount for a particular integrated circuit (such as an LM2678 semiconductor) and also with landing pads for various supporting components to be used with the particular IC. The landing pads may be designed to accommodate a variety of combinations of supporting components, which vary in size and shape, by creating the landing pads for the supporting components large enough and spaced closely enough to accommodate different sizes of components that may potentially be used with the IC. Thus, a single PCB board may be used to accommodate many different schematics, having various sizes and varieties of surface mount components.

The electrical simulation module 516 may be configured to allow for an electrical simulation of an electrical schematic, allowing for a user to observe the performance of the circuit under simulated operating conditions. The electrical simulation module 516 may be utilized to determine the behavior of the output voltage of a power supply design 125 over time as the load current is raised and lowered in a short amount of time to simulate a load transient.

The thermal simulation module 518 may be configured to identify heat problems on a PCB early on in the design process and correct the issues before a PCB goes into production. Early diagnosis of a thermal issue may save a time and avoid costly quality issues. The thermal simulation module 518 may be configured to simulate the thermal behavior of an electronic PCB having various components. The thermal simulation module 518 may use thermal models for components to aid in the analysis. For PCBs that are laid out using a standard PCB layout, the thermal simulation module 518 may further utilize a thermal model for the standard PCB layout.

The operating values module 520 may be configured to calculate key operating values for a circuit design, such as duty cycle, current through individual components, component power dissipation, efficiency, component temperatures, phase margin, crossover frequency, and other parameters important to the design.

Based on the PCB and components, the thermal simulation module 518 may utilize a conduction, radiation and/or convection solver. The thermal simulator module 518 may model the temperature of the PCB, power supply components 205 and surrounding space utilizing the power dissipation of power supply components 205, physical models of the components and PCB, and environmental conditions such as the ambient temperature, forced airflow velocity, PCB boundary conditions, PCB orientation, etc. The output of the thermal simulation may be illustrated graphically by way of the user interface module 502, such as by a color contour plot of the PCB under the design's steady state electrical load 120 conditions, illustrating an estimate of the generated heat.

The bill of materials module 522 may be configured to determine a BOM including the list of parts used for each of the generated power supply designs. The bill of materials module 522 may further determine a total cost of the design and a total number of components for the power supply design. For example, the bill of materials module 522 may query the data store 145 for component information 150 related to pricing of the utilized components, and may determine an overall cost of the power supply design 125 based on a total sum of the cost of each utilized component.

The best results determination module 524 may be utilized to determine one or more best results from a set of power supply designs 125. For instance, the best results determination module 524 may determine a ranking of the individual designs in the set of power supply designs 125. The best results determination module 524 may determine the ordering and recommended designs by using a weighted scoring system. As an example, a design requirement 130 may indicate a preference for power supply designs 125 having high efficiency. Accordingly, based on the design requirement 130, the best results determination module 524 may rank the power supply designs 125 according to electrical efficiency for the overall power supply designs 125, where the overall efficiencies may be determined by the electrical simulation module 516.

The best results determination module 524 may determine the ordering while accounting for multiple variables simultaneously. Similar to as discussed above with regard to component selection, the best results ordering may use an algorithm in which a target value is set for one or more parameters of a power supply design 125. The closer a parameter of the power supply design 125 is to the corresponding target, the higher the score for that parameter. A weight may also be assigned to each parameter. Thus, a final score for each power supply design 125 may be determined based on the initial score and the weight (e.g., as a product of the score and weight values). For example, if two parameters with a same deviation from a target value have different weights, the one with the higher weight would receive a higher overall score. This weighted scoring algorithm allows ordering of power supply designs 125 taking into account multiple parameters at once, keeping a balance between important characteristic factors such as efficiency, footprint, BOM cost, BOM component count, and V.sub.out peak to peak ripple.

In some instances, the best results determination module 524 may utilize a cutoff to provide up to a maximum number of power supply designs 125. As an example, a cutoff may indicate a maximum total number of power supply designs 125 to include in the universe of possible designs.

The best results determination module 524 may further determine a recommended design determined to have a good balance between design tradeoffs. For example, the best results determination module 524 may determine the one of the power supply designs 125 having the best ranking as being the overall recommended design.

The tabular display module 526 may be configured to display a list of the determined power supply designs 125 by way of the user interface module 502. For example, the tabular display module 526 may present a user interface 110 including a table of power supply designs 125 with parameters 210 displayed, with each row in the table indicating a particular power supply design 125 and associated values and parameters 210. Parameters 210 may include system footprint determined by the board layout module 514, system BOM cost and system component count determined by the bill of materials module 522, system efficiency determined by the operating values module 520, among others.

The values in the table may be arranged according to the ranking determined by the best results determination module 524. For instance, values in the table may be arranged with the best recommendation or recommendations at the top of a sortable list. As an example, a design requirement 130 may indicate a preference for designs having high efficiency. Accordingly, based on ranking determined by the best results determination module 524, the power supply designs 125 may be displayed in order according to electrical efficiency.

The graphical display module 528 may be configured to provide a graph of the determined power supply designs 125 by way of the user interface module 502. The graphical display module 528 may represent the tradeoffs between the various power supply designs 125 by representing various parameters 210 as the X and Y axes of the graph. The graphical display module 528 may further represent the points within the graph as items of varying attributes, such as of varying size and/or color. For example, circles of different diameters may be used to signify correspondingly larger or smaller values. As another example, different colors may be used to represent differences in the values being plotted. This may allow the graphical display module 528 to indicate a third parameter 210 as a third dimension of the graph and a fourth parameter 210 as a fourth dimension of the graph.

As an example, the axes may default to parameters 210 of system footprint and system efficiency, with a circle around each data point of variable size to represent the BOM cost. The size of the circle may accordingly vary in size to become larger for a higher BOM cost and smaller for a lower BOM cost. The graphical display module 528 may be configured to allow a user to configure the axes of the graph, allowing the user to visualize other parameters 210 of the design, such as the Vₒᵤₜ peak to peak ripple, frequency, BOM count, among others.

The design list filter module 530 may be configured to allow for the filtering of the determined power supply designs 125 displayed by the tabular display module 526 and graphical display module 528. For example, the design list filter module 530 may provide slider controls, check boxes and other controls by way of the user interface module 502 that may be used to specify filter criteria for the displayed power supply designs 125. These controls may allow a user of the user device 105 to narrow down the list of power supply designs 125 according to the specified filter criteria. Because the filtering is performed based on the determined set of power supply designs 125 that form the universe of possible designs, filtering of the power supply designs 125 may be performed by the user device 105 without requiring any additional database access or interaction with the data store 145.

Exemplary filter criteria may include minimum and maximum efficiency, minimum and maximum footprint, minimum and maximum BOM cost, minimum and maximum BOM count, minimum and maximum ripple, minimum and maximum switching frequency, minimum and maximum crossover frequency, and minimum and maximum phase angle. Further exemplary filter criteria may include additional power supply component 205 features, such as: on/off pin, error pin, soft start, external synchronization, module, adjustable primary leakage inductance limit, adjustable frequency, synchronized switching, controller, and integrated switch. Still further exemplary filter criteria may include manufacturer and channel supplier.

The optimization control module 532 may be configured to allow a user to specify system level goals such as small footprint, low cost, or high efficiency. The optimization control module 532 may utilize the user interface module 502 to present one or more controls to a user device 105 in a user interface 110, and may receive input from the user from the one or more controls. The control or controls may allow the user to select a tradeoff indicating a preference for at least one parameter 210 over a preference for at least one other parameter 210. For example, a control may allow the user to prefer designs with small footprint over designs with high efficiency. The design tradeoff selected by way of the optimization control module 532 may provide the visualizer design tool application 160 with input regarding user preferences for parameters 120 over other parameters 120. This tradeoff information may then be used by the visualizer design tool application 160 for various purposes.

In some implementations, the design tradeoff may be used to control the generation of power supply designs 125. For example, based on the input from the control, the optimization control module 532 may be configured to cause the visualizer design tool application 160 to calculate power supply designs 125 containing power supplies optimized according to the system level goals indicated by the user. These power supply designs 125 may then be displayed to the user.

In other implementations, the design tradeoff may be used to filter a set of determined power supply designs 125. For example, the visualizer design tool application 160 may be configured to pre-calculate power supply designs 125 optimized according to each of the potential system level goals or sets of optimizations settings that may be indicated by the optimization control module 532. Then, based on input received from one or more optimization controls, the optimization control module 532 may be configured to cause the visualizer design tool application 160 to filter the displayed power supply designs 125 according to the particular optimization settings chosen by the user. By performing the filtering based on the pre-calculated power supply designs 125, optimized according to each of the optimizations settings available from the optimization controls, the filtering may be performed by the user device 105 without requiring any additional database access or interaction with the data store 145.

An exemplary optimization control module 532 may present a knob providing for selection of one of the following five sets of optimizations to use as the system design goals: a first optimization with the goals of smallest possible footprint accomplished through use of the highest possible switching frequencies; a second optimization with the goals of lowest cost with frequency pushed high to get smaller components; a third optimization with the goals of a balance of efficiency, footprint, low complexity, and cost; a fourth optimization with the goals of low cost with frequency pushed lower for increased efficiency; and a fifth optimization with the goal of highest possible efficiency.

The component acquisition module 534 may be configured to allow a user to purchase the list of parts used in a selected power supply design 125. Using the BOM for a power supply design 125, the component acquisition module 534 may be configured to confirm whether the parts are in stock by querying the component information 150 stored in data store 145. If the parts are determined to be in stock, the component acquisition module 534 may allow the user to purchase a set of parts for building all or a portion of the power supply design 125. The component acquisition module 534 may further be configured to provide assembly instructions for the board that shows the locations of all the components, soldering instructions, an electrical schematic, top-side and bottom-side copper layout diagrams, instructions for building and testing the circuit. In some examples, the component acquisition module 534 may provide an option for the user to receive an assembled version of the power supply design 125.

The architecture navigation module 536 may be configured to allow for navigation of the electrical schematic, such as the schematic determined by the schematic determination module 512. Upon selection of one of the power supply designs 125, such as through use of the tabular display module 526 and the graphical display module 528, the architecture navigation module 536 may be configured to display, by way of the user interface module 502, a user interface 110 including a schematic of the selected design. The architecture navigation module 536 may also be configured to allow the user to navigate to other modules such as a table of key operating values, charts of key operating values, electrical simulation, thermal simulation, optimization of the design for key goals and the ability to get a prototype kit of the design.

The report module 538 may be configured to create a report summarizing the attributes of one or more designs. For example, the report module 538 may be utilized by a user to view a report summarizing the attributes of a selected design from the set of power supply designs 125. The report may include system level key attributes 210 such as system efficiency, system BOM cost, footprint area, and BOM count. The report may further include specific information about the required input voltage source 115. In addition, the report may include information about the power supply design 125, including the corresponding schematic, BOM, and associated component information including electrical characteristics such as inductance, DC resistance, current rating, voltage rating, etc. Other information about the power supply design 125 may be included as well, such as operating values including duty cycle, efficiency, BOM cost, BOM footprint, currents through components, and power dissipation for components. The operating values may be included in a table or as plots of the operating value vs. other facts such as load 120 current for different voltages. The report may also contain simulation results, such as from the electrical simulation module 516 and/or thermal simulation module 518, which may be represented in numeric form, tabular form such as via tabular display module 526, and/or graphical form such as via graphical display module 528. Reports generated by the report module 538 may be provided in various formats, such as the portable document format (PDF).

FIG. 6 illustrates an exemplary process flow 600 for the visualization of power supply designs 125 according to designs requirements 130. The process 600 may be performed by various systems, such as by the system 100 described above with respect to FIG. 1.

In block 610, a visualizer design tool application 160 receives design requirements 130 from a user device 105. In some examples, the design requirements may include advanced design options, as described in this disclosure. For example, a communications network 135 may be in selective communication with a user device 105 and an application site 140. The application site 140 may serve as a hosting platform for an application server 155 running the visualizer design tool application 160. A user interface module 502 and a requirements module 504 of the visualizer design tool application 160 may be configured to provide a user interface 110 to a user device 105, such as a web page, where the user interface 110 may allow the user of the user device 105 to specify the design requirements 130 for a power supply design 125. The design requirements 130 may include information regarding a load 120 to be powered by an input voltage source 115. The design requirement 130 may further include specification of a set of design goals and tradeoffs that may be used to optimize the power supply designs 125.

In block 620, the visualizer design tool application 160 determines a set of power supply components 205. For example, a component determination module 506 of the visualizer design tool application 160 may be configured to determine a set of power supply components 205 that each could satisfy the design requirements 130 by applying filters to component information 150 stored in data store 145. The filters may compare values specified in the design requirements 130 for the load 120, such as output voltage and output current, against values in corresponding information in the component information 150. The component determination module 506 may further utilize values from the design requirements 130 relating to the input voltage source 115 as inputs to one or more design heuristics 165, where the outputs of the one or more design heuristics 165 may be used to determine which power supply components 205 could potentially satisfy the load 120 from the input voltage source 115.

In block 630, the visualizer design tool application 160 generates power supply designs 125 for the determined power supply components 205. For example, the visualizer design tool application 160 may utilize a component determination module 506, a circuit design module 508, and a circuit optimization module 510 to determine, for each power supply component 205, supporting components that could be used to build circuits for the power supply components 205, optimized according to the design goals and tradeoffs indicated in the design requirements 130.

For example, the circuit design module 508 may utilize design heuristics 165 incorporating rules and mathematical formulas to select ranges of values for supporting components to be used with the power supply components 205. The circuit optimization module 510 may determine supporting components that satisfy the range of potential values determined by the circuit design module 508, while also accounting for design goals and tradeoffs indicated in the design requirements 130 through use of optimization heuristics 170. These optimizations and design goals and tradeoffs may accordingly guide the determination of some or even all of the power supply components 205 and supporting components of the power supply designs 125.

In block 640, the visualizer design tool application 160 determines parameters 210 of the determined power supply designs 125. For example, the visualizer design tool application 160 may utilize a schematic determination module 516 to produce an electrical schematic diagram, and a board layout module 514 to create a PCB layout according to the determined schematic. Then the visualizer design tool application 160 may utilize an electrical simulation module 516 to simulate the load transient behavior of the determined electrical schematic, and a thermal simulation module 518 to simulate the thermal behavior of the PCB layout. The power supply design tool application 160 may also utilize a bill of materials module 522 to determine a BOM including the list of parts used and the total part count for each of the power supply designs 125. The power supply design tool application 160 may also use an operating values module 520 to calculate the electrical efficiency of the circuit. In some examples, visualizer design tool application 160 may determine the set of power supply components, generate power supply designs, and/or determine parameters based on one or more advanced design options.

In block 650, the visualizer design tool application 160 ranks the determined power supply designs 125. This ranking may be determined based on the design goals and tradeoffs indicated in the design requirements 130. For example, the best results determination module 524 may utilize an ordering algorithm in which a target value is set for one or more parameters 210 of a power supply design 125. The closer a parameter 210 of the power supply design 125 is to the corresponding target, the higher the score for that parameter 210. A weight may also be assigned to each parameter 210 based on the design goals and tradeoffs specified by the user in the design requirements 130. Thus, a final score for each power supply design 125 may be determined based on the initial score and the weight (e.g., as a product of the score and weight values). For example, if two parameters with a same deviation from a target value have different weights, the one with the higher weight would receive a higher overall score. This weighted scoring algorithm allows ordering of power supply designs 125 taking into account multiple parameters 210 at once, keeping a balance between important characteristic factors specified by the design requirements 130. The visualizer design tool application 160 may utilize the best results determination module 524 to determine one or more best results from a set of power supply designs 125 as the designs having the best ranking.

In block 660, the visualizer design tool application 160 graphically displays tradeoffs between the power supply designs 125. For example, the visualizer design tool application 160 may send the power supply designs 125 to the user device 105 that form the universe of possible designs for the design requirements 130. The user device 105 may utilize a tabular display module 526 to display a table of the power supply designs 125 and parameters 210, with each row in the table indicating a particular power supply design 125 and associated values. The visualizer design tool application 160 may also utilize a graphical display module 528 to provide a graph of the determined power supply designs 125 representing tradeoffs between the various power supply designs 125 according to parameters 210. In some examples, the visualizer design tool application 160 presents an indication of the best one or more power supply designs 125. Because the universe of possible power supply designs 125 has already been computed by the visualizer design tool application 160, the user device 105 may perform filtering of the determined power supply designs 125 displayed by the tabular display module 526 and graphical display module 528 without additional access or interaction with the data store 145. After block 660, the process 600 ends.

FIG. 7 illustrates an exemplary user interface 110-A for a visualizer design tool application 160. The user interface 110-A may include user input controls 705 for specifying design requirements 130 for requested power supply designs 125, a tabular list control 710 for the display of the power supply designs 125, a graphical display control 715 for the illustration of design tradeoffs among the power supply designs 125, and filtering controls 720 for filtering power supply designs 125. The controls 705-720 of user interface 110-A may be generated by a user interface module 502 of a visualizer design tool application 160. The user interface 110-A may be displayed by a user device 105 (e.g., in a web browser executing on the user device), and allow for a user of the user device 105 to input design requirements 130 for power supply designs 125 to be generated by the visualizer design tool application 160. The user interface 110-A may also allow for the user to visualize, filter, and select power supply designs 125 generated by the visualizer design tool application 160. The user interface 110-A also can be used to select various advanced options through selection of an advanced options control 707 (described below).

The user input controls 705 may allow for a user of a user device 105 to input design requirements 130 for power supply designs 125. For example, the user input controls 705 may provide for the input of details of an input voltage source 115 to power the power supply designs 125, as well as details of a load 120 to be powered by the power supply designs 125. The user input controls 705 may further allow for the input of design requirements 130 relating to design tradeoffs or design goals relating to optimizations of the power supply designs 125.

The tabular list control 710 may be created by a tabular display module 526 of the visualizer design tool application 160 and may allow for the display of a tabular representation of the generated power supply designs 125. The tabular list control 710 may display values for parameters 210 of the power supply designs 125 such as efficiency, footprint, BOM cost, and BOM count.

As shown in the example of FIG. 7, a plurality of power supply designs 125 are included in a tabular list control 710. The tabular list control 710 may be created by a tabular display module 526 of the visualizer design tool application 160. The tabular list control 710 may include a plurality of rows of data, where each row of data corresponds to one of the power supply designs 125. In cases where there are more power supply designs 125 than fit in the tabular list control 710, the tabular list control 710 may provide for scrolling through the power supply designs 125, such as by way of a scroll bar control. The tabular list control 710 may further indicate that one of the power supply designs 125 has been selected such as through highlight of the selected row/design.

The tabular list control 710 may include a plurality of columns, where each column may include a header labeling the included information as well as the information on the labeled aspect of the power supply designs 125. In some examples, the columns may include a part number for a power supply component 205 included in the power supply design 125, a schematic diagram of the power supply design 125, representations of the components and their relative size as included in the power supply design 125, design considerations related to the power supply design 125, footprint for the power supply design 125, BOM cost and count for power supply design 125, efficiency for the power supply design 125, frequency at which the power supply component 205 operates, voltage ripple, crossover frequency, phase margin, topology (e.g., Boost, Buck, Buck-Boost, etc.), Iout max, and IC cost. Additional or different columns of information may be included in other implementations. To facilitate review of the plurality of power supply design 125, the tabular list control 710 may be configured to be sorted in ascending or descending order by column.

The graphical display control 715 may be created by a graphical display module 528 of the visualizer design tool application 160 and may allow for the graphical display of tradeoffs among the power supply designs 125. The graphical display control 715 may graph values corresponding to various parameters 210 of the power supply designs 125. The graphical display control 715 plots the various power supply designs based on, in this example, three variables. Each power supply design is plotted based on footprint size (y-axis) and efficiency (x-axis). Each power supply design is represented as a circle whose size is dependent on a third parameter such as BOM cost, where a larger circle represents a larger cost and a smaller circle represents a smaller cost.

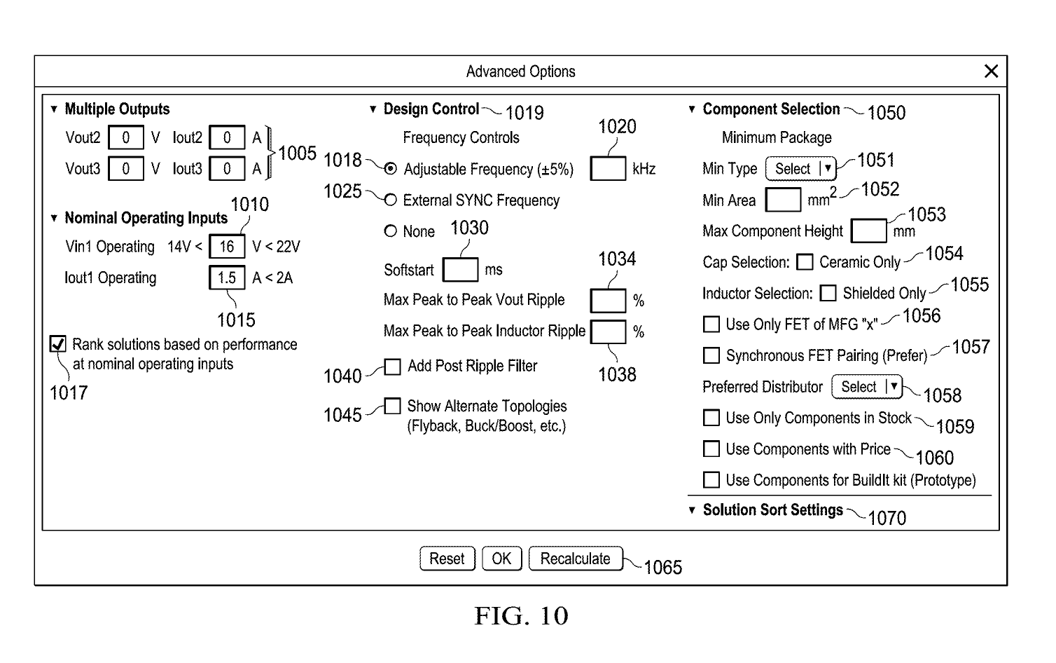

The filtering controls 720 may allow for the filtering of power supply designs 125 according to various filter criteria. For example, the power supply designs 125 displayed in the tabular list control 710 and the graphical display control 715 may be filtered to correspond to the criteria entered into the filtering controls 720. Further details regarding the filtering controls 710 are discussed below with respect to FIG. 10.

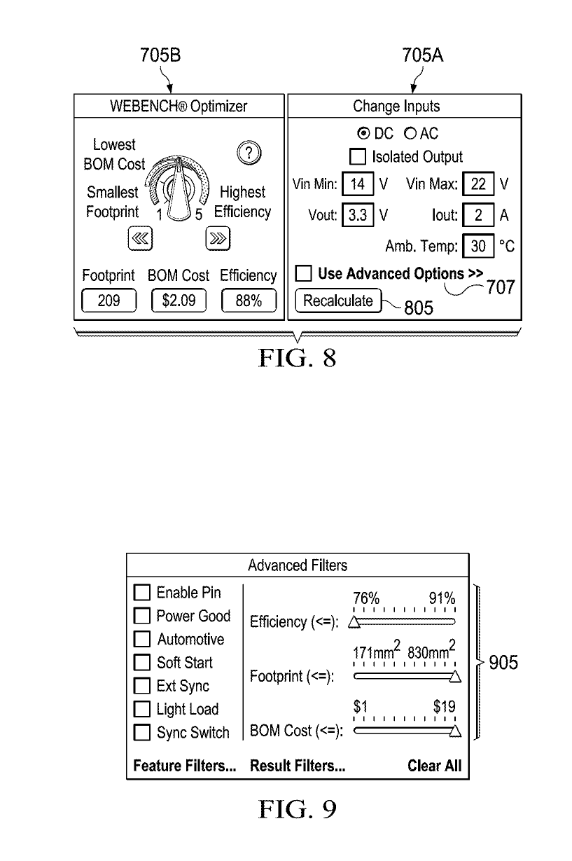

FIG. 8 illustrates an exemplary user interface for at least some input design requirements 130 for power supply designs 125. The illustrative user interface may include user input controls 705-A for specifying design requirements 130 for an input voltage source 115 and a load 120. The user interface may further include user input controls 705-B for specifying design tradeoffs. Additionally, the user interface may include a calculate control 805 configured to request the visualizer design tool application 160 to generate power supply designs 125 responsive to the design requirements 130 entered into the input controls 705-A and 705-B.

The input controls 705-A may include controls for the input of design requirements 130 related to the input voltage source 115 to power the power supply designs 125 and the load 120 to be powered by the power supply designs 125. Exemplary design requirements 130 that may be specified by the input controls 705-A include minimum and maximum input voltage of the input voltage source 115, output voltage and current for the load 120. The input controls 705-A may further allow for the specification of additional design requirements 130, such as an ambient temperature to consider for the power supply designs 125. The advanced options control 707 also is shown in FIG. 8 and will be further explained below with regard to FIG. 10. The advanced options control 707 permits the user to select from many more design options and requirements.

The input controls 705-B may include controls for the input of design requirements 130 related to design tradeoffs between parameters 210 of the power supply designs 125. For example, an optimization control module 532 of the visualizer design tool application 160 may utilize the user interface module 502 to allow a user to specify system level goals such as small footprint, low cost, and/or high efficiency. The input controls 705-B may allow the user to select a tradeoff indicating a preference for at least one parameter 210 over a preference for at least one other parameter 210. For example, the control may allow the user to prefer designs with small footprint over designs with high efficiency.

In some instances, the optimization control module 532 may utilize the user interface module 502 to present the input control 705-B in the form of a knob, where each position of the knob represents different design tradeoffs between various design goals. As shown in FIG. 8, the input controls 705-B may present a knob providing for selection of one of the following sets of optimizations to use as the system design goals: a first optimization with the goals of smallest possible footprint accomplished through use of the highest possible switching frequencies; a second optimization with the goals of lowest cost with high frequency for smaller components; a third optimization with the goals of a balance of efficiency, footprint, low complexity, and cost; a fourth optimization with the goals of lowest cost with frequency pushed lower for increased efficiency; and a fifth optimization with the goal of highest possible efficiency, but with large components.

The calculate control 805 may be configured to request the visualizer design tool application 160 to generate power supply designs 125 responsive to the design requirements 130 entered into the input controls 705. The user interface of FIG. 8 may further allow for the user to use the input controls 705 to update the design requirements 130. Then, the calculate control 805 may be selected by the user to generate new power supply designs 125 responsive to updated design requirements 130.

FIG. 9 illustrates an example of a user interface for filtering the power supply designs 125. The user interface may include filtering controls 905 for specifying filter criteria to use when filtering a set of power supply designs 125. The filtering may be performed by a design list filter module 530 of the visualizer design tool application 160, and may allow for filtering of the power supply designs 125 by the user device 105 according to filter criteria specified by filtering controls 905. Because the filtering is performed based on the determined set of power supply designs 125 that form the universe of possible designs, filtering of the power supply designs 125 may be performed without requiring any additional database access or interaction with the data store 145. Thus, the filtering may be performed by a user device 105, without interaction with an application server 155. In the example of FIG. 8, efficiency, footprint size and BOM cost may be controlled to filter the results, although different or additional parameters may be used as well to filter the results. The check boxes on the left-hand side of FIG. 9 provide additional options for filtering the results. For example, the “soft start” button can be selected to only provide results that provide for a soft start capability as described above.

FIG. 10 shows an example of a user interface for the advanced options selectable through the advanced options control 707 (FIG. 7). The advanced options permits a user to specify that the power supply design should provide more than one output voltage. The user interface of FIG. 7 allows a user to specify the output voltage and current, but if the user intends for the power supply to drive multiple loads, the user can specify that the power supply design should generate a second or a third output voltage and corresponding current 1005.

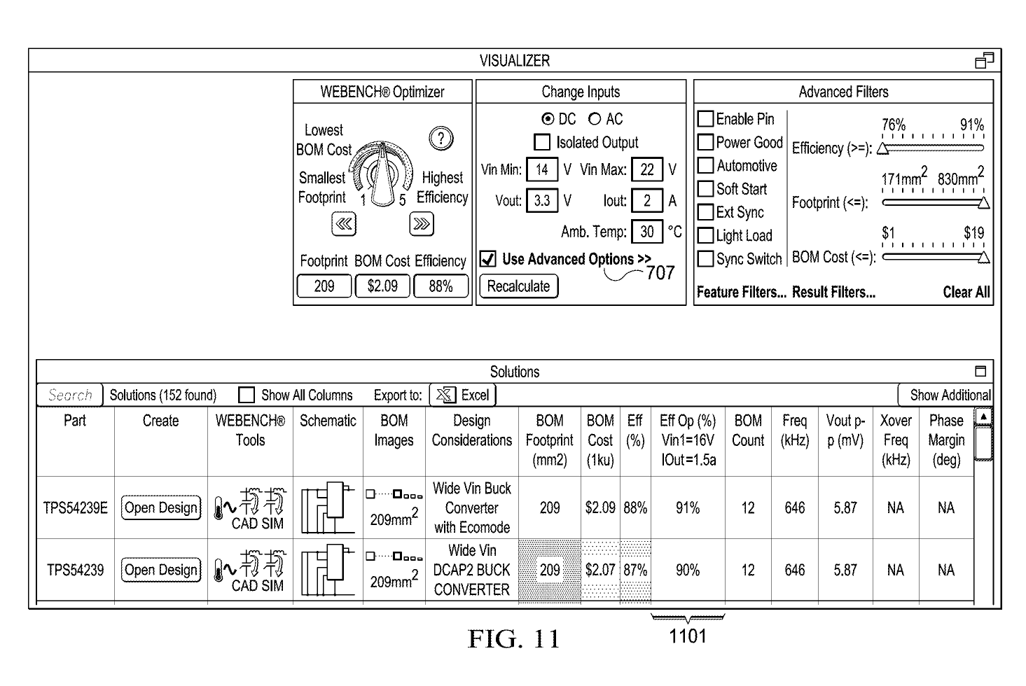

In the user interface of FIG. 7, the user can specify a range of input voltages (e.g., Vin min and Vin max). In the advanced options a user can specify a nominal input voltage in data entry field 1010. The nominal input voltage may be a voltage that the user believes will be the input voltage most of the time. For example, in the example of FIG. 10, the user has input 16 V as the nominal input voltage. This means that, while the power supply design should be capable of functioning with an input voltage between 14 V and 22 V, most of the time (e.g., 80% of the time), the input voltage is expected to be 16 V. As will be seen with reference to FIG. 11, the nominal input voltage is used by the design tool to calculate an efficiency for the nominal operating voltage in addition to an efficiency at Vin max.

In addition to, or instead of, a nominal input voltage, a user can specify a nominal expected output current in data entry field 1015. In the example of FIG. 10, although the user has specified that the power supply design must be able to source 2 A of current, the nominal operating is expected to be 1.5 A. The nominal operating current must be equal to or less than the maximum operating current, and the nominal operating voltage must be equal to or between Vin min and Vin max. Check box 1017 lets a user specify that the power supply designs should be ranked in table based on the performance at the specified nominal operating voltage and/or current.

The advanced options user interface includes a design control section 1019 and a component selection 1050. The design control section 1019 permits a user to specify various device or circuit performance values, while the component selection 1050 includes various device physical attributes. Both sets of user controls are explained below.

Some users may want to have control over the operating frequency of the power supply. Thus, if the user selects the adjustable frequency control 1018, a data entry field 1020 is created on the user interface. Data entry field 1020 permits a user to input a desired operating frequency for the power supply, which the design tool then uses when designing the power supply circuits. In one example, a resistance value for timing resistor can be calculated based on the frequency value entered by the user in data entry field 1020. The timing resistor's resistance value may be inversely proportional to the user specified frequency. For a TPS54388-Q1 device, the resistor value may be computed using the manufacturer supplied equation:

$${f}_{( sw )} ( KHz ) = \frac{131904 ( M Ω \text{/} s )}{{Rt}^{0.9492} ( K Ω )}$$

where f(sw) is the user specified frequency. The equation may be stored in the component information 150.

Other users instead may want the power supply circuit to be synchronized to an external clock. Those users can select the external SYNC frequency control 1025. Selection of this control also causes a data entry field to be displayed (not shown) by which a user can enter a desired SYNC frequency requirement.

The soft start data entry field 1030 allows a user to enter a time value (e.g., measured in units of milliseconds). The soft start feature allows the voltage converter to gradually reach a steady-state operating point, thereby reducing startup stresses and current surges or inrush current. All power supply devices in the database (e.g., component information 150) which support external soft start time control and have a minimum soft start time greater than or equal to the specified soft start time in data entry field 1030 are optimized, ranked and presented to the user.

Data entry fields 1034 and 1038 allow a user to specify a maximum output voltage ripple percentage and maximum inductor current ripple percentage, respectively. The user-supplied maximum output voltage ripple percentage value represents the percentage of the output voltage that the ripple can be and is used by the design tool to calculate and select the output capacitor for the design. All devices with lower than or equal to the specified voltage ripple are optimized, ranked and present to the user. Similarly, the user-supplied maximum inductor current ripple percentage value is used by the design tool to calculate and select the output inductor for the design. All devices with lower than or equal to the specified inductor current ripple are optimized, ranked and present to the user.

With regard to the maximum output voltage ripple, capacitors are characterized by a capacitance value and an equivalent series resistance (ESR) value, as well as other parameters. The user-specified maximum output voltage ripple percentage is used to calculate the maximum permitted ESR for the output capacitor. Once the maximum permitted ESR is calculated as well as the output capacitance value, the design tool can select an appropriate capacitor from the database. For example, the output capacitance may be calculated by the design tool based on various known equations (provided by capacitor manufacturers on their datasheets) such as percentage of output voltage which is allowed to drop during load transient, desired steady-state ripple, minimum allowed capacitance, etc.

The output voltage will nominally be the output voltage specified by the user, but will fluctuate between a minimum and maximum level. The fluctuation is the voltage ripple. In some cases, the equations to calculate the minimum and maximum output voltage may be:

$$VoutMin = ( 0.5 + \frac{Lp 2 p}{C} ) * T min * ( - 1.0 + \frac{T min}{Ton} )$$

$$VoutMax = ( 0.5 + \frac{Lp 2 p}{C} ) * T max * ( 1.0 + \frac{T max}{Toff} )$$

where Lp2p is the inductor peak to peak current, C is the output capacitance, Tmin is the time period at which the output voltage is minimum, Ton is the on time, Tmax is the time period at which the output voltage is maximum and Toff is the off time. Once Voutmin and Voutmax are calculated, the rippled voltage across the capacitor can be calculated as the difference between Voutmax and Voutmin. The design tool can calculate the maximum permitted ripple voltage across the ESR as the product of the nominal output voltage and the maximum output voltage ripple percentage value input by the user in data entry field 1034. The maximum ESR value then may be calculated as the maximum permitted ripple voltage across the ESR divided by Lp2p. The equations mentioned above may be stored in the component information 150.

With regard to the maximum permitted inductor current ripple percentage entered by the user in data entry field 1038, the design tool may calculate a value of the inductor using an equation supplied by the inductors' manufacturers. In one example, the equation to calculate inductance may be:

$$L = \frac{{Vin}_{max} - Vout}{Iout * Kind} * \frac{Vout}{{Vin}_{max} - Fsw}$$

where L is the target inductor value, Vinmax is the maximum input voltage, Vout is the maximum output voltage, Fsw is the switching frequency, and Kind is the ripple factor coefficient (e.g., the user-supplied value in data entry field 1038). The equation to calculate the inductance may be stored in the component information 150.

Referring still FIG. 10, check box 1040 lets a user specify that a ripple filter is to be added to the design. For example, an LC filter is added by the design tool to the power supply circuit's output. The added LC filter allows the user to reduce the output voltage ripple.

Check box 1045 allows a user to view various power supply architectures such as flyback converters, buck/boost converters, etc. If check box 1045 is selected, various architectures offered by the design tool may be displayed for the user, and the user can select any particular architectures he or she wishes to use to the exclusion of the others (or specify those architectures not desired to be used).

Component selection 1050 allows a user to specify various component parameters. The choices in this example are illustrated at 1051-1060. Option 1051 allows a user to specify a minimum package size from a list of standard sizes (e.g., 0201, 0402, 0603, 0805, etc.). Option 1052 allows a user to specify a minimum footprint area (e.g., in units of millimeters). Option 1053 allows a user to specify a maximum component height. Option 1054 can be selected to specify that only those capacitors that are ceramic capacitors are to be used in the design. Whether the inductor is to be a shielded inductor can be selected by check option 1056. Many power supply circuits include a pair of transistors (e.g., high side FET and low side FET). Option 1057 permits the user to specify that the transistors are to be identical.

A user can specify that only a certain parts distributor is to be used through option 1058. The design tool will then only use the parts from the component information 150 that are distributed by that particular distributor. The component information n150 also may include the price of the parts in the database, but some price data may be missing. Option 1060 can be selected to cause the design tool to only use parts from the database that have price data associated therewith.

Once one or more of the advanced options are selected or otherwise specified in the user interface of FIG. 10, the user can select the “recalculate” control 1065. The user interface then reverts back to the user interface of FIG. 7, however, the power supply designs presented in the table may be computed based on the advanced options the user selected. FIG. 11 shows an example of user interface based on the user having selected the nominal operating input voltage of 16V and the nominal output current of 1.5 A. The user interface is similar to that shown in FIG. 7 (generated before the specification of any advanced options). In addition the listed power design circuits potentially being different, a difference in the two user interfaces is that in FIG. 11, a second efficiency column 1101 has been added which computes the efficiency of the circuit operating at the nominal operating values as specified by the user.

The advanced options user interface of FIG. 10 also includes a solution sort settings control 1070. When this control is activated by the user, a user interface is generated and presented to the user such as that shown in FIG. 12. The solution sort settings allow the user to specify custom weight settings for each of various parameters such as efficiency, BOM cost, footprint, and BOM count. Sliders, or other types of user controls, are displayed which allow a user to customize the weighting for each parameter independently.

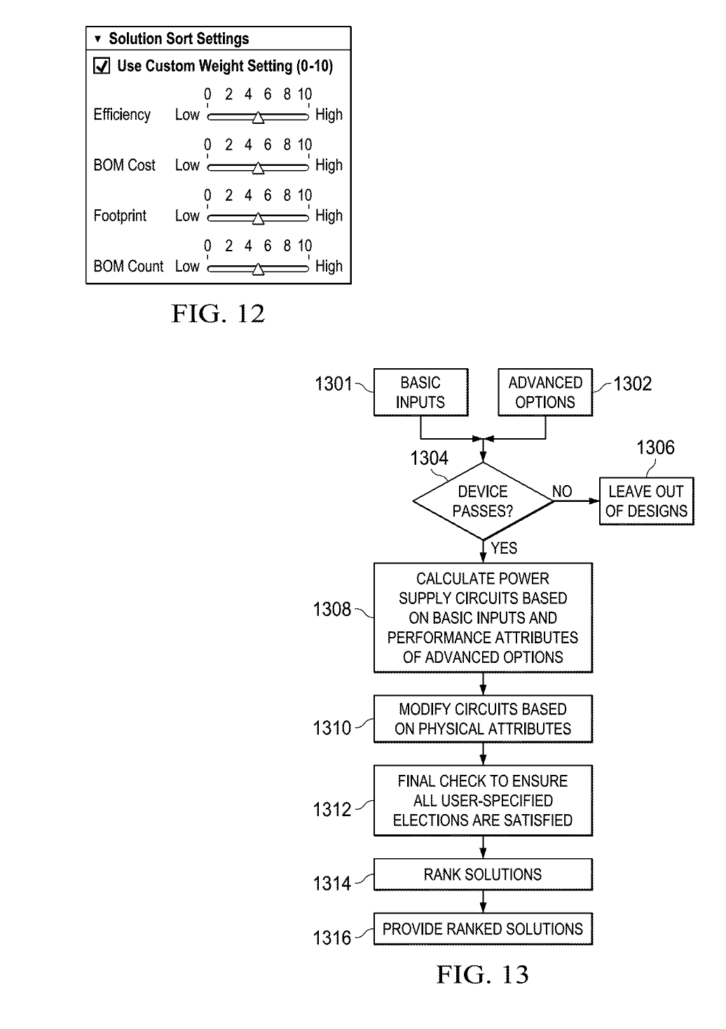

FIG. 13 shows an example of method in accordance with the various embodiments. The method includes the use of the advanced options. The method may be performed by the application server upon execution of the visualizer design tool application 160. The operations depicted may be performed in the order shown, or in a different order. Further, the operations may be performed sequentially or two or more of the operations may be performed concurrently.

At 1301, the method includes receiving basic user inputs for the design of the power supply circuit. The basic user inputs may be provided by way of user device 105 and may include an input voltage, an output voltage, an output current, and an ambient temperature. The input voltage may be specified as a single input voltage or a minimum input voltage and a maximum input voltage (i.e., a range of input voltage). The input voltage also may be specified as an AC voltage or a DC voltage.

At 1302, the design tool receives any of a number of various advanced options as explained above. Such options may include various performance options (e.g., within design control section 1019 in FIG. 10) and various device physical attributes (e.g., component selection 1050). The performance options may include frequency, synchronization to an external clock, soft start timing, maximum output voltage ripple, maximum inductor current ripples, etc. Physical attributes may include package type, area, height, ceramic capacitors, etc. In some embodiments, the design tool generates data that is to be populated into a user interface such as a web page and transmitted across a network to the user device 105 for rendering in a user interface on the user device. In some examples, the data populated in the user interface may include the various advanced options shown in FIG. 10.

At 1304, the method includes determining which, if any, devices in the database do not comply or permit compliance with the basic user inputs. Those devices are excluded at 1306 from further consideration and thus are not used in the power supply circuit designs. For those components that do pass this initial device filtering step, the method includes at 1308 calculating one or more power supply circuits based on the basic user inputs and performance attributes of the advanced options.

At 1310, the calculated circuits from 1308 may be modified based on the physical attributes the user has specified in the advanced options (e.g., component selection 1050). For example, if the user has specified that only ceramic capacitors are to be used or that only components having a certain maximum height are to be used, then the circuits are modified or recalculated to ensure compliance with such physical attribute requirements.

At 1312, a final check of the circuit solutions may be made to ensure that all user-specified elections are satisfied. The resulting solutions are then ranked at 1314 per the user settings and provided at 1316. Providing the solutions may include transmitting the circuit solutions to a user device 105 for display in a web browser, transmitting a file that contains the circuit solutions, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a database configured to store information including characteristics of a plurality of electrical components;
a computing resource in communication with the database and configured to:
receive design requirements indicative of a desired power supply design, the design requirements including an input voltage, an output voltage, an output current, and a value indicative of maximum output voltage ripple;
query the database for electrical components that comply with the input voltage, output voltage, and output current;
generate a plurality of power supply designs that satisfy the input voltage, output voltage, and output current, and for each power supply design:
calculate an output capacitor value and an output capacitor ripple;
calculate a total ripple based on the value indicative of maximum output voltage ripple;
calculate a capacitor equivalent series resistance value based on the total ripple and based on the output capacitor ripple; and
select a capacitor from the database for the power supply design based on the calculated output capacitor value and the capacitor equivalent series resistance value; and
provide the plurality of power supply designs in an order based on a priority parameter.

2. The system of claim 1, wherein the computing resource is further configured to receive a design requirement that includes a value indicative of an inductor current ripple, and wherein for each power supply design, the computing resource is configured to calculate an inductor value based on the value indicative of the inductor current ripple.

3. The system of claim 1, wherein the computing resource is further configured to receive a design requirement that includes a frequency value, and wherein for each power supply design, the computing resource is configured to calculate a value of a timing resistor based on the frequency value.

4. The system of claim 1, wherein the computing resource is further configured to receive a design requirement that includes an external frequency value, and wherein the computing resource is configured to generate the power supply design to include power supply components that permit synchronization to an external clock having the external frequency value.

5. The system of claim 1, wherein the computing resource is further configured to receive a packaging parameter that includes at least one of a minimum package size for each component in each power supply design, a maximum height for each component in each power supply design, a setting that a ceramic component is to be used in each power supply design, a setting that a shield inductor is to be is to be used in each power supply design, that matching transistors are to be included in each power supply design, and a setting that that only components in stock are to be includes in each power supply design.

6. The system of claim 1, wherein the computing resource is further configured to:
receive an input setting that indicates that a filter is to be added on to the output of each power supply design; and
for each power supply design, include an output passive filter.

7. The system of claim 1, wherein the input voltage includes a minimum input voltage and a maximum input voltage and the output current is a maximum output current, and wherein the computing resource is further configured to also receive a nominal input voltage and a nominal output current and to compute an efficiency value for each power supply design based on the nominal input voltage and a nominal output current.

8. A method, comprising:
receiving, at a computing resource, a plurality of design requirements including an input voltage value, an output voltage value, an output current, and at least one of a frequency, a soft start time value, a value indicative of maximum output voltage ripple, a value indicative of maximum inductor current ripple;
identifying a plurality of electrical components from a database that comply with the design requirements;
generating a plurality of power supply designs including the identified plurality of electrical components, each design satisfying the design requirements; and
transmitting the generated plurality of power supply designs.

9. The method of claim 8, wherein the received plurality of design requirements includes the value indicative of the maximum output voltage, and wherein the method further includes:
computing a maximum equivalent series resistance for an output capacitor based on the value indicative of the maximum output voltage ripple;
computing an output capacitance value; and
selecting capacitor from a database based on the computed output capacitance value and having an equivalent series resistance less than the computed maximum equivalent series resistance.

10. The method of claim 8, wherein the received plurality of design requirements includes the value indicative of the maximum inductor current ripple, and wherein the method further includes computing an inductor value based on the value indicative of the maximum inductor current ripple.

11. The method of claim 8, wherein the received plurality of design requirements includes the frequency, and wherein for each power supply design, the method includes calculating a value of a resistor based on the frequency value.

12. The method of claim 8, wherein the plurality of design requirements includes a requirement that the power supply design is to be synchronized to an external clock.

13. The method of claim 8, wherein the plurality of design requirements includes a device physical attribute including at least one of a minimum package size, a maximum height for each component in each power supply design, a setting that a ceramic component is to be used in each power supply design, a setting that a shield inductor is to be is to be used in each power supply design, that matching transistors are to be included in each power supply design, and a setting that that only components in stock are to be includes in each power supply design.

14. The method of claim 8, further comprising:
receiving an input setting that indicates that a filter is to be added on to the output of each power supply design; and
for each power supply design, include an output passive filter.

15. The method of claim 8, wherein the input voltage includes a minimum input voltage and a maximum input voltage and the output current is a maximum output current, and wherein the method further includes receiving a nominal input voltage and a nominal output current.

16. The method of claim 15, further comprising computing an efficiency value for each power supply design based on the nominal input voltage and a nominal output current.

17. A method, comprising:
receiving, at a computing resource, a plurality of basic design requirements including an input voltage value, an output voltage value, an output current;
generating, by the computing resource, data to be populated into a user interface, the data including user-selectable advanced options, the advanced options including a frequency, a soft start time value, a value indicative of maximum output voltage ripple, a value indicative of maximum inductor current ripple, and a device physical attribute;
transmitting, by the computing resource, the data across a network for inclusion in a user interface;
receiving, at the computing resource, a selected advanced option;
using electrical components from a data store, generating a plurality of power supply designs that satisfy the basic design requirements and the selected advanced option; and
transmitting, by the computing resource, the generated plurality of power supply designs.

18. The method of claim 17, wherein the selected advanced option includes the value indicative of the maximum output voltage, and wherein the method further includes:
computing a maximum equivalent series resistance for an output capacitor based on the value indicative of the maximum output voltage ripple;
computing an output capacitance value; and
selecting capacitor from a database based on the computed output capacitance value and having an equivalent series resistance less than the computed maximum equivalent series resistance.

19. The method of claim 17, wherein the device physical attribute includes a package type, an area size, and a component height.

20. The method of claim 17, wherein the frequency in the advanced options specifies the frequency of the power supply design.
